(19) United States
(12) Patent Application Publication
(10) Pub. No.: US 2026/0296627 A1
(43) Pub. Date: Oct. 1, 2026

(54) CLAMPED GLAZING UNIT AND GLAZING ASSEMBLY COMPRISING SAME

(71) Applicant: SAINT-GOBAIN SULLY, SULLY-SUR-LOIRE (FR)

(72) Inventors: Adrien DUFFOUR, SULLY SUR LOIRE (FR); Jean Benoit MAYEUX, SULLY SUR LOIRE (FR)

(21) Appl. No.: 19/489,076

(22) PCT Filed: May 16, 2024
(86) PCT No.: PCT/FR2024/050633

§ 371 Date: Dec. 1, 2025

(30) Foreign Application Priority Data
Jun. 1, 2023 (FR) FR2305505

(51) Int. Cl. B64C 1/14

(52) U.S. Cl. CPC B64C 1/1492

(57) ABSTRACT

A clamped glazing unit includes a glazing unit configured to be held peripherally between an outer flange and an inner flange, the glazing unit including an outer layer, an inner structural layer and at least one intermediate structural layer, wherein an interlayer connects two consecutive layers of the glazing unit and a peripheral seal is configured to be sandwiched between the outer flange and the inner flange, the peripheral seal being overmolded onto the inner structural layer, wherein at least one layer of the at least one intermediate structural layer is secured to the peripheral seal by a clamping device that has an anchoring portion rigidly attached to the peripheral seal and a clamping portion clamping the at least one layer of the at least one intermediate structural layer beyond its edge.

The invention relates to a lightweight clamped glazing unit intended for use in the aeronautics industry.

The glazing units used in the aeronautics industry are working glazing units and clamped glazing units.

Clamped glazing units, which are the subject of the invention, comprise layers, also referred to as sheets in a laminated glazing unit, separated by interlayers: an inner structural layer, an outer layer and at least one intermediate structural layer.

In order to provide the fail-safe function, which guarantees that the glazing unit remains in place in the event of breakage of one of the structural layers, the inner structural layer and at least one intermediate structural layer, generally the intermediate structural layer adjacent to the inner structural layer in the stack of layers forming the clamped glazing unit, are retained by a seal overmolded onto the glazing unit, the overmolded seal being clamped between a structure and the aircraft fuselage, which forms an external lip on the clamped glazing unit.

At the same time, for aerodynamic reasons, the outer layer must be flush with the aircraft fuselage. It must therefore face the edge of the aircraft fuselage, in the plane or substantially in the plane thereof, and, as it is not located between the structure and the fuselage of the aircraft that clamp the overmolded seal, it cannot be retained by the overmolded seal.

The gap between the outer layer and the other structural layers of the glazing unit located below the plane of the aircraft fuselage with respect to the outer layer must therefore be compensated for by a greater interlayer thickness.

The disadvantage of this embodiment according to the state of the art is that it imposes a significant interlayer thickness under the outer layer, which provides no additional function, but constitutes additional mass, reducing the overall performance of the aircraft, such as range or fuel consumption.

The evolution of glazing unit sizes has led to a parallel increase in the thickness of the structural elements and thus to an increase in the thickness of the glazing units, contributing to an even greater overall weight, with some glazing units comprising an interlayer thickness of over 11 mm.

The invention proposes to overcome these drawbacks of the state of the art and to ensure the clamping of the intermediate structural layer performing the fail-safe function by means of a clamping device, a part of which is secured to the overmolded seal. The intermediate structural layer clamped by the clamping device no longer has to be clamped by the overmolded seal, and can therefore be shifted closer to the outer layer in the stack layers of the glazing unit, thus reducing the thickness of the interlayer under the outer layer. This clamping device ensures continuity between the clamped intermediate structural layer and the seal in the event of a breakage of the structural layer, thus providing a fail-safe function.

In the present application, the term “layer” is understood to mean a sheet of laminated glazing.

The term “structural layer” is used for a layer that adds mechanical strength to the glazing unit.

The terms “inner”, “internal”, “outer” and “external” are to be understood in the present application as referring to the inside and the outside, respectively, of the aircraft in which the clamped glazing unit of the invention is intended to be installed.

The invention relates to a clamped glazing unit comprising a glazing unit configured to be held peripherally between an outer flange and an inner flange, the glazing unit comprising an outer layer, an inner structural layer and at least one intermediate structural layer, wherein an interlayer connects two consecutive layers of the glazing unit and a peripheral seal is configured to be sandwiched between the outer flange and the inner flange, the peripheral seal being overmolded onto the inner structural layer, the clamped glazing unit being characterized in that at least one layer of the at least one intermediate structural layer is secured to the peripheral seal by a clamping device having an anchoring portion secured to the peripheral seal and a clamping portion clamping the at least one layer of the at least one intermediate structural layer beyond its edge.

In this way, the one or more clamped structural layers can be offset from the space between the outer flange and the inner flange, in order to come substantially level with the outer flange, making it possible to reduce the interlayer thickness between the outer layer and the one or more clamped intermediate structural layers.

According to one embodiment, the glazing unit comprises a single intermediate structural layer.

This single intermediate structural layer is therefore clamped by the clamping device, bringing it closer to the outer layer.

According to one embodiment, the glazing unit comprises two intermediate structural layers, at least one of which is clamped by the clamping device.

According to one embodiment, the clamping device is continuous around the periphery of the glazing unit in order to clamp the at least one intermediate structural layer around the entire periphery thereof, thus ensuring optimum holding of the glazing unit in the event of a breakage of one of the layers of the glazing unit.

According to one embodiment, the clamping device is mounted in segments on the periphery of the glazing unit in order to clamp the at least one intermediate structural layer around all or part of the periphery thereof.

According to one embodiment, a first intermediate structural layer is clamped by a first clamping device and a second intermediate structural layer is clamped by a second clamping device, each clamping device being either a continuous clamping device on the periphery of the glazing, for clamping the corresponding intermediate structural layer over its entire periphery, or a clamping device mounted in segments on the periphery of the glazing unit, for clamping the corresponding intermediate structural layer over all or part of the periphery thereof.

According to one embodiment, the clamping device comprises two legs made of either a composite material or a metal material, which can be secured to the at least one intermediate structural layer by bonding.

According to one embodiment, at the anchoring portion of the clamping device, the two legs are secured to the peripheral seal with an insert lodged between the two legs, the insert being made of either a composite material, an organic material, a thermoplastic material, or a metal material. According to another aspect of the invention, at the anchoring portion of the clamping device, the two legs are secured to the peripheral seal by bonding them together using either an interlayer or a structural adhesive.

According to one embodiment, the clamped glazing unit further comprises a seal configured to extend from the outer flange over the outer layer to form a clear opening on the outer layer. Clear opening is understood herein to mean the visible part of the outer layer.

According to one embodiment, a sealing device is arranged on the outer layer, the sealing device having a leg which is inserted between the peripheral portion of the glazing unit and the peripheral seal in order to be inserted onto the clamping device.

According to one embodiment, the outer layer comprises a heating device.

The invention also relates to a glazing assembly comprising an outer flange and an inner flange peripherally sandwiching a clamped glazing unit as previously defined.

To better exemplify the subject matter of the present invention, particular embodiments will now be described, by way of non-limiting example, in connection with the appended drawings.

In the drawings:

FIG. 1 is a schematic cross-sectional view of a glazing unit of the state of the art.

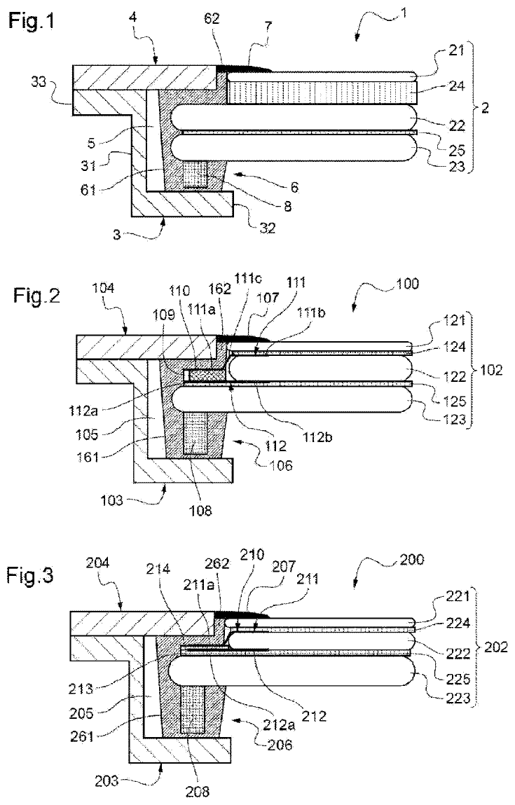

FIG. 2 is a schematic cross-sectional view of a glazing unit according to a first embodiment.

FIG. 3 is a schematic cross-sectional view of a glazing unit according to a second embodiment.

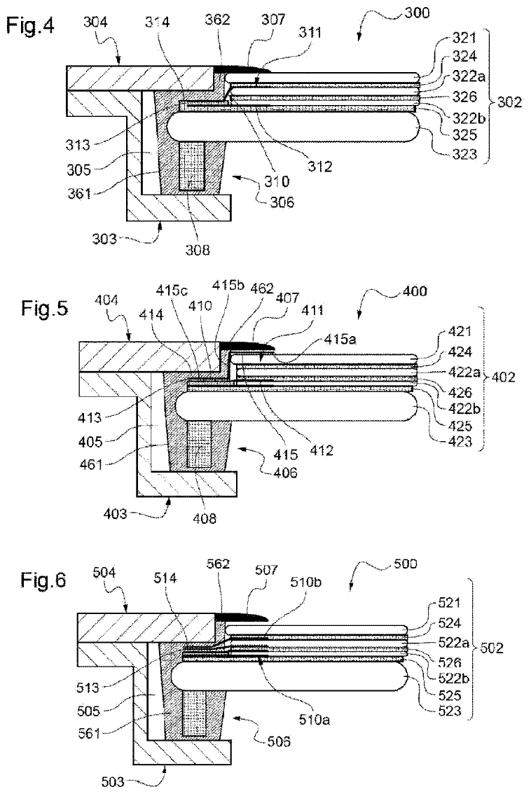

FIG. 4 is a schematic cross-sectional view of a glazing unit according to a third embodiment.

FIG. 5 is a schematic cross-sectional view of a glazing unit according to a fourth embodiment.

FIG. 6 is a schematic cross-sectional view of a glazing unit according to a fifth embodiment.

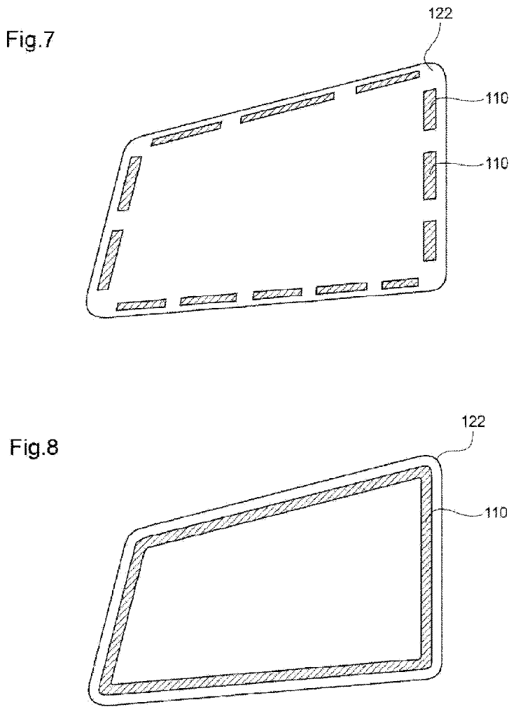

FIG. 7 is a schematic view depicting the grip of the clamping device on the clamped intermediate structural layer according to a first variant of the invention.

FIG. 8 is a schematic view depicting the grip of the clamping device on the clamped intermediate structural layer according to a first variant of the invention.

FIG. 1 depicts the state of the art for a clamped glazing unit 1, which comprises a glazing unit 2 sandwiched between an inner flange 3 and an outer flange 4. The glazing unit 2 comprises an outer layer 21, an intermediate structural layer 22 and an inner structural layer 23, with an interlayer 24 between the outer layer 21 and the intermediate structural layer 22 and an interlayer 25 between the intermediate structural layer 22 and the inner structural layer 23. Typically, for a laminated glazing unit, the interlayers 24, 25 are made of plastic, such as polyvinyl butyral (PVB) or polyurethane (PU) or equivalent, and secure the various layers of the glazing unit 2 together.

By way of non-limiting example for the embodiment shown, the inner flange 3 has a cross-sectional shape having a vertical portion 31, with two right-angled returns 32, 33 at each end, the two right-angled returns 32, 33 extending in opposite directions to give the inner flange 3 a substantially straight Z-shape.

The outer flange 4 has a plate-shaped cross section, serving as an external lip on the inner flange 3, with one part of the outer flange 4 resting on the right-angled return 33, the other part of the outer flange 4 projecting opposite the right-angled return 32 to form a receiving space 5 between the inner flange 3 and the outer flange 4. In practice, the outer flange 4 is attached to the inner flange 3, the inner flange 3 being integral with the structure of the aircraft.

It is understood that the invention is not limited in these regards and that the inner flange 3 and the outer flange 4 can have any shape, provided that a receiving space 5 is formed therebetween.

A peripheral seal 6 is received in the receiving space 5, with one part 61 of the seal overmolded on the inner structural layer 23, the interlayer 25 and the intermediate structural layer 22, and one part 62 of the seal extending between the outer flange 4 on one side and the outer layer 21 and the interlayer 24 on the other side.

As can be seen in FIG. 1, the interlayer 24 has a greater thickness to compensate for the height between the intermediate structural layer 22, overmolded on the part 61 of the seal 6 under the outer flange 4, and the outer layer which is flush with the outer surface of the outer flange 4.

A seal 7 (also referred to as bead) is applied between the outer flange 4 and the outer surface of the outer layer 21, to ensure aerodynamic continuity between these two surfaces, and thus limit the effects of drag and noise caused by aerodynamic discontinuities. The free edge of the seal 7 delimits the clear opening of the outer layer 21. The seal 7 is part of the glazing unit, wears out and is regularly repaired during the service life of the glazing unit.

Finally, an insert 8 can be formed in the part 61 of the seal 6, in order to impart rigidity to the assembly overmolded in the part 61 of the seal 6.

FIG. 2 depicts a first embodiment of the invention.

In this embodiment, elements equivalent to the elements described in connection with FIG. 1 hereinbefore for the state of the art will bear the same reference sign increased by 100 when they have the same structure, and will not be described in further detail.

The clamped glazing unit 100 comprises a glazing unit 102 sandwiched between an inner flange 103 and an outer flange 104. The glazing unit 102 comprises an outer layer 121, an intermediate structural layer 122 and an inner structural layer 123, with an interlayer 124 between the outer layer 121 and the intermediate structural layer 122 and an interlayer 125 between the intermediate structural layer 122 and the inner structural layer 123. Typically, for a laminated glazing unit, the interlayers 124, 125 are made of plastic, such as polyvinyl butyral (PVB) or polyurethane (PU) or the like, and secure the various layers of the glazing unit 102 together.

The inner structural layer 123 and the interlayer 125 are overmolded in the part 161 of the seal 106.

Conversely, the intermediate structural layer 122 is no longer overmolded in the part 161 of the seal 106, but is secured to the part 161 of the seal 106 by a clamping device 110, consisting of two legs 111 and 112, which peripherally clamp the intermediate structural layer 122.

The upper leg 111 (in FIG. 2) comprises a part 111a overmolded in the part 161 of the seal 106, a set-back part 111c and a part 111b extending over the edge of the glazing unit 122 facing the outer layer 121.

The lower leg 112 comprises a part 112a overmolded in the part 161 of the seal 106 and a part 112b extending over the edge of the glazing unit 122 facing the inner structural layer 123.

An insert 109 is provided between the parts 111a and 112 a of the legs 111 and 112 in order to stiffen the clamping device 110. The insert 109 and the legs 111, 112 of the clamping device 110 are bonded before the seal 106 is overmolded.

The other elements are otherwise identical to those described for FIG. 1 and will not be further described herein.

The clamping device 110, by allowing the intermediate structural layer 122 to be pulled out of the part 161 of the seal 106, enables the intermediate structural layer 122 to be raised towards the outer layer 121, thus reducing the thickness of the interlayer 124, which results in a significant weight saving, while retaining the characteristics of the clamped glazing unit, namely the outer layer 121 flush with the outer flange 104, with height compensation between the two by the seal 107, and a fail-safe feature, since the two structural glazing units 122 and 123 are secured to the seal 106, the inner structural layer 123 by overmolding the seal 106 around it as in the state of the art, and the intermediate structural layer 122 by the clamping device 110.

FIG. 3 depicts a clamped glazing unit 200 according to a second embodiment.

Elements having the same structure as the first embodiment will bear the same reference sign increased by 100, and will not be described in further detail herein.

The difference between the second embodiment and the first embodiment lies in the fact that the parts 211a and 212a of the legs 211 and 212 of the clamping device 210 are secured in an interlayer 213 and a structural adhesive 214, the whole assembly being overmolded in the part 261 of the seal 206.

FIG. 4 depicts a clamped glazing unit 300 according to a third embodiment.

Elements having the same structure as the second embodiment will bear the same reference sign increased by 100, and will not be described in further detail herein.

The difference between the third embodiment and the second embodiment lies in the difference in the number of intermediate structural layers in the glazing unit.

Indeed, in this third embodiment, there are two intermediate structural layers 322a and 322b, separated by an interlayer 326.

The leg 311 extends over the edge of the intermediate structural layer 322a facing the outer layer 321, while the leg 312 extends over the edge of the intermediate structural layer 322b facing the inner structural layer 323.

As in the previous embodiment, the clamping device 310 of this embodiment is secured in the interlayer 313 with a structural adhesive 314, around which the part 361 of the seal 306 is overmolded.

This embodiment shows that the clamping device 310 can clamp several intermediate structural layers (two in this embodiment), the invention not being limited by the number of intermediate structural layers that the clamping device 310 can clamp.

FIG. 5 depicts a clamped glazing unit 400 according to a fourth embodiment.

Elements having the same structure as the third embodiment will bear the same reference sign increased by 100, and will not be described in further detail herein.

The difference between the fourth embodiment and the third embodiment is that the clamping device 410 only clamps the intermediate structural layer 422b, and the intermediate structural layer 422a is not secured to the seal 406.

A sealing device 415 is formed, with a horizontal leg 415a extending over the outer edge of the outer layer 421, a vertical leg 415b extending between the glazing unit 402 and the part 462 of the seal 406, and a second horizontal leg 415c extending over the anchored portion of the clamping device 410, this sealing device 415 making it possible to guarantee improved sealing of the clamped glazing unit 400. Although not shown for the other embodiments, this sealing device may find application in the other embodiments which are not limited in these regards.

In this embodiment, the fail-safe function is provided by the intermediate structural layer 422b.

FIG. 6 depicts a clamped glazing unit 500 according to a fifth embodiment.

Elements having the same structure as the fourth embodiment will bear the same reference sign increased by 100, and will not be described in further detail herein.

In this embodiment, two clamping devices 510a and 510b, respectively, are secured to the part 561 of the seal 506, the first clamping device 510a clamping the intermediate structural layer 522b, the second clamping device 510b clamping the intermediate structural layer 522a.

As in the previous embodiment, the two clamping devices 510a and 510b are secured to the part 561 of the seal 506 by means of the interlayer 513, between each leg of the clamping devices 510a and 510b, and by means of a structural adhesive 514, bonding the two devices 510a and 510b in the seal 506.

FIGS. 7 and 8 exemplify the impression that the clamping device can make on the one or more intermediate structural layers that it clamps.

FIG. 7 depicts the intermediate structural layer 122 of FIG. 2, wherein the clamping device 110 is mounted in segments on the periphery of the intermediate structural layer 122.

FIG. 8 depicts the intermediate structural layer 122 of FIG. 2, wherein the clamping device 110 is mounted continuously on the periphery of the intermediate structural layer 122.

It is understood that the segmented or continuous nature of the clamping device 110, exemplified in FIGS. 7 and 8 with the first embodiment, can be applied to all the embodiments of the invention.

Each layer of the glazing units according to the embodiments of the invention may be organic or mineral, the invention not being limited in these regards.

Similarly, the invention is not limited by the structures and shapes of the outer and inner flanges described in connection with the embodiments depicted.

Finally, the invention is not limited by the number of clamping devices securing one or more intermediate structural layers to the seal within a single clamped glazing unit, which may, for example, comprise a first clamping device clamping one or more intermediate structural layers, a second clamping device clamping one or more separate intermediate structural layers, or even more clamping devices.

Typically for aeronautical glazing units, the glazing unit may comprise a heating device, formed on the outer layer in the form of a heating layer or heating wires, which are electrically powered.

1. A clamped glazing unit comprising a glazing unit configured to be held peripherally between an outer flange and an inner flange, the glazing unit comprising an outer layer, an inner structural layer and at least one intermediate structural layer, wherein an interlayer connects two consecutive glazing layers and a peripheral seal is configured to be sandwiched between the outer flange and the inner flange, the peripheral seal being overmolded onto the inner structural layer wherein at least one layer of the at least one intermediate structural layer is secured to the peripheral seal by a clamping device that has an anchoring portion secured to the peripheral seal and a clamping portion clamping the at least one layer of the at least one intermediate structural layer beyond its edge, and wherein the clamped structural layer or layers of the at least one intermediate structural layer are offset from the space between the outer flange and the inner flange

2. The clamped glazing unit according to claim 1, wherein the glazing unit comprises a single intermediate structural layer

3. The clamped glazing unit according to claim 1, wherein the glazing unit comprises two intermediate structural layers at least one of which is clamped by the clamping device

4. The clamped glazing unit according to claim 1, wherein the clamping device is continuous over the a periphery of the glazing unit in order to clamp the at least one intermediate structural layer over an entire periphery thereof.

5. The clamped glazing unit according to claim 1, wherein the clamping device is mounted in segments on the periphery of the glazing unit in order to clamp the at least one intermediate structural layer over all or part of the periphery thereof.

6. The clamped glazing unit according to claim 3, wherein a first intermediate structural layer is clamped by a first clamping device and a second intermediate structural layer is clamped by a second clamping device each clamping device being either a continuous clamping device on the periphery of the glazing unit, for clamping the corresponding intermediate structural layer over its an entire periphery thereof, or a clamping device mounted in segments on the a periphery of the glazing unit, for clamping the corresponding intermediate structural layer over all or part of the periphery thereof.

7. The clamped glazing unit according to claim 1, wherein the clamping device comprises two legs made of either a composite material or a metal material.

8. The clamped glazing unit according to claim 7, wherein the legs, are secured to the at least one intermediate structural layer by bonding.

9. The clamped glazing unit according to claim 7, wherein, at the anchoring portion of the clamping device the two legs are secured to the peripheral seal with an insert lodged between the two legs the insert being made of either a composite material, an organic material, a thermoplastic material, or a metal material.

10. The clamped glazing unit according to claim 7, wherein, at the anchoring portion of the clamping device the two legs are secured to the peripheral seal by bonding them together using either an interlayer or a structural adhesive.

11. The clamped glazing unit according to claim 1, further comprising a seal configured to extend from the outer flange over the outer layer to form a clear opening on the outer layer.

12. The clamped glazing unit according to claim 1, wherein a sealing device is arranged on the outer layer, the sealing device having a leg which is inserted between the peripheral portion of the glazing unit and the peripheral seal in order to be inserted onto the clamping device

13. The clamped glazing unit according to claim 1 wherein the outer layer comprises a heating device.

14. A glazing assembly comprising an outer flange and an inner flange peripherally sandwiching a clamped glazing unit according to claim 1.
